(19) United States
(12) Patent Application Publication
(10) Pub. No.: US 2018/0309331 A1
(43) Pub. Date: Oct. 25, 2018

(54) MOTOR STRUCTURE FOR AN ELECTRIC WHEELCHAIR

(71) Applicant: DONGCHANG MOTOR (SHENZHEN) CO., LTD., Shenzhen, Guangdong (CN)

(72) Inventor: Shaoqiang LAN, Shenzhen, Guangdong (CN)

(21) Appl. No.: 15/738,115

(22) PCT Filed: Dec. 30, 2016
(86) PCT No.: PCT/CN2016/113635

§ 371 Date: Dec. 19, 2017

(30) Foreign Application Priority Data
Nov. 24, 2016 (CN) 201611059610.4

(51) Int. Cl. H02K 1/17; H02K 13/00; H01R 39/04; A61G 5/04

(52) U.S. Cl. CPC H02K 1/17; A61G 5/04; H01R 39/04; H02K 13/006

(57) ABSTRACT

A motor structure for an electric wheelchair, includes a housing, a front cover, a rear cover, a rotating shaft, a rotor, a commutator sleeved on the rotating shaft and electrically connected to the rotor, and a brush power terminal fixed to the front cover and in contact with the commutator, and further including a plurality of tile-shaped magnets surrounding the rotor, a cross-section of each tile-shaped magnet is a symmetric structure about an axis thereof, each tile-shaped magnet includes an inner curved surface and an outer curved surface, and the centre of the circle corresponding to the inner curved surface and the centres of circles corresponding to the outer curved surface lie on a straight line and are distanced apart.

### FIELD OF TECHNOLOGY

The present invention relates to the field of technology in motors, in particular, to a motor structure for an electric wheelchair.

### BACKGROUND TECHNOLOGY

At present, the electric wheelchair industry mostly uses traditional brushed motors as power sources. Due to irregular waveforms of the stator magnetic fields in the existing brushed motors, electromagnetic interference is large, leading to relatively large current when starting the motors, long time constant, large impact on the power sources, thereby leading to poor control and safety as well as short service life of the motors and electric wheelchairs; at the same time, during operation of the existing brushed motors, the contact resistance between a carbon brush and a commutator is large and the contact resistance is unstable, thereby affecting the operation efficiency of the motors.

### SUMMARY OF THE INVENTION

The objective of the present invention is to solve the shortcomings of the prior art and to provide a motor structure for an electric wheelchair.

A technical solution of the present invention is:

A motor structure for an electric wheelchair, including a housing, a front cover fixed at a front of the housing, a rear cover fixed at a back of the housing, a rotating shaft, a rotor sleeved on the rotating shaft and fixedly connected with the rotating shaft, a commutator sleeved on the rotating shaft and electrically connected to the rotor, and a brush power terminal fixed to the front cover and in contact with the commutator, and further including a plurality of tile-shaped magnets surrounding the rotor, a cross-section of each tile-shaped magnet is a symmetric structure about an axis thereof, each tile-shaped magnet includes an inner curved surface and an outer curved surface, and a centre of a circle corresponding to the inner curved surface and centres of circles corresponding to the outer curved surface lie on a straight line and are distanced apart.

A preferred embodiment is that the outer curved surface includes a first arc portion, transition portions extending from two ends of the first arc portion, and second arc portions extending from other ends of the transition portions, the first arc portion and the second arc portions are evenly transitioned through the transition portions, a centre of a circle corresponding to the first arc portion is located at an external side of the centre of the circle corresponding to the inner curved surface, a centre of a circle corresponding to each transition portion coincides with the centre of the circle corresponding to the inner curved surface, and a centre of a circle corresponding to each second arc portion is located at an internal side of the centre of the circle corresponding to the inner curved surface.

A preferred embodiment is that a corresponding radius of the first arc portion is 34.9 mm˜35.1 mm.

A preferred embodiment is that a corresponding central angle of the first arc portion is 90 degrees.

A preferred embodiment is that a corresponding radius of each second arc portion is 34.5 mm˜34.7 mm.

A preferred embodiment is that an outer end of each second arc portion is a horizontal plane and the width of the horizontal plane is 3.1 mm˜3.2 mm.

A preferred embodiment is that a corresponding radius of the inner curved surface is 26.92 mm˜27.18 mm.

A preferred embodiment is that two ends of the inner curved surface are provided with transition arcs.

A preferred embodiment is that the commutator includes a plurality of commutator segments, a surface roughness of each commutator segment is 1.27 microns˜2.03 microns, a height difference between adjacent commutator segments is less than or equal to 1.27 microns, a height difference between two sides of each commutator segment is less than or equal to 1.27 microns, and a curvature of the commutator composed of the plurality of commutator segments is less than or equal to 2.54 microns.

A preferred embodiment is that the number of commutator segments is 16 pieces.

According to the above technical solutions, the beneficial effects of the present invention are: because the centre of the circle corresponding to the inner curved surface and the centres of circles corresponding to the outer curved surface lie on a straight line and are distanced apart, therefore, magnetic waveforms generated by the tile-shaped magnets are relatively smooth, electromagnetic interference is small, leading to relatively small current when starting the motor, the smaller the time constant, the smaller impact on the power source, the better control and safety as well as longer service life of the motor and electric wheelchair.

The above description is only an overview of the technical solutions of the present invention. In order to clearly understand the technical means of the present invention, the present invention can be implemented according to the contents of the specification, and in order to make the above and other objectives, features and advantages of the present invention more obvious and understandable, the preferred embodiments are described below with reference to the accompanying drawings, which are described in detail below.

### DESCRIPTION OF THE DRAWINGS

FIG. 1 is an exploded view of the present invention;

FIG. 2 is a perspective view of the tile-shaped magnet according to the present invention;

FIG. 3 is a front view of the tile-shaped magnet according to the present invention; and

FIG. 4 is a top view of the tile-shaped magnet according to the present invention.

### DETAILED DESCRIPTION OF THE EMBODIMENTS

It should be noted that, in the case of no conflict, the embodiments in the present application and the features in the embodiments may be combined with each other. The invention is further described below with reference to the accompanying drawings.

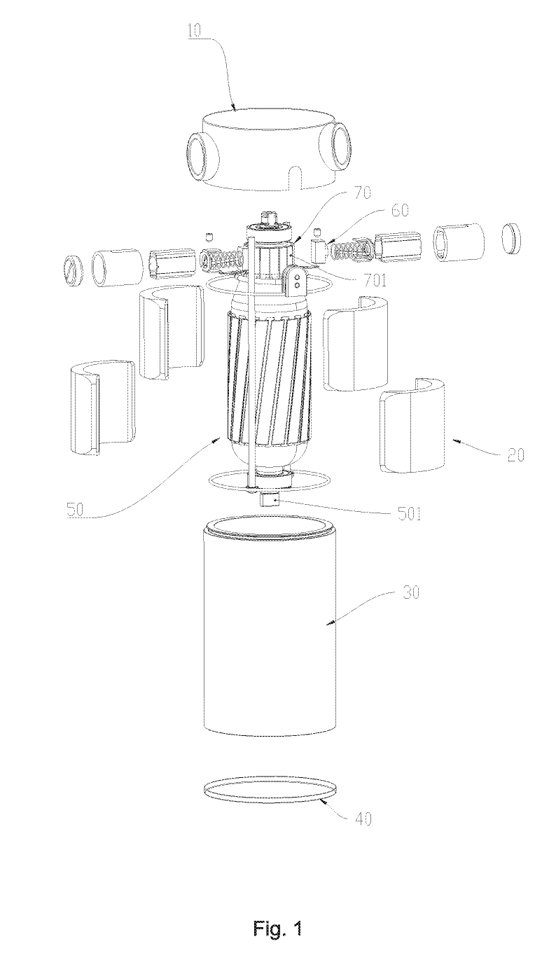

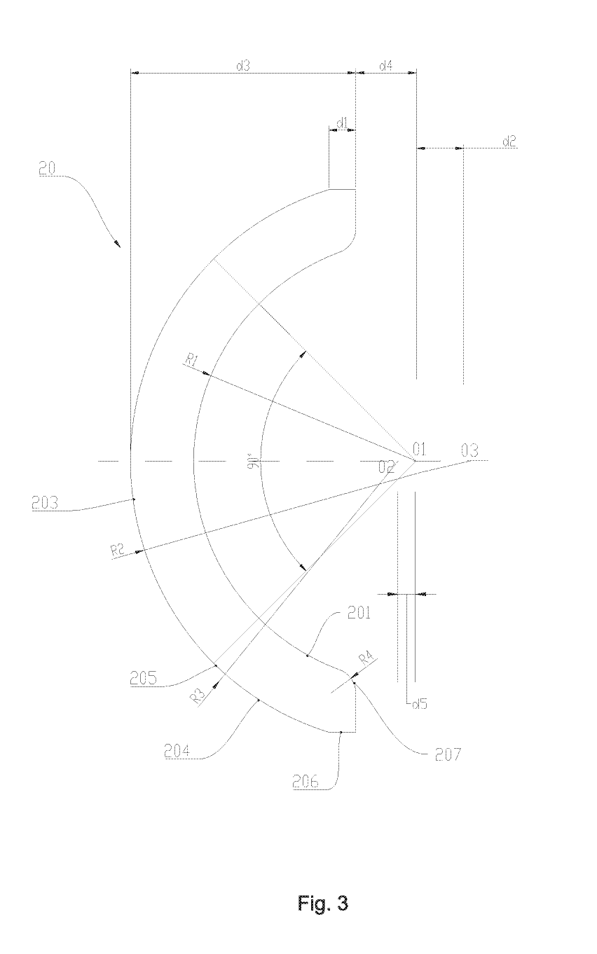

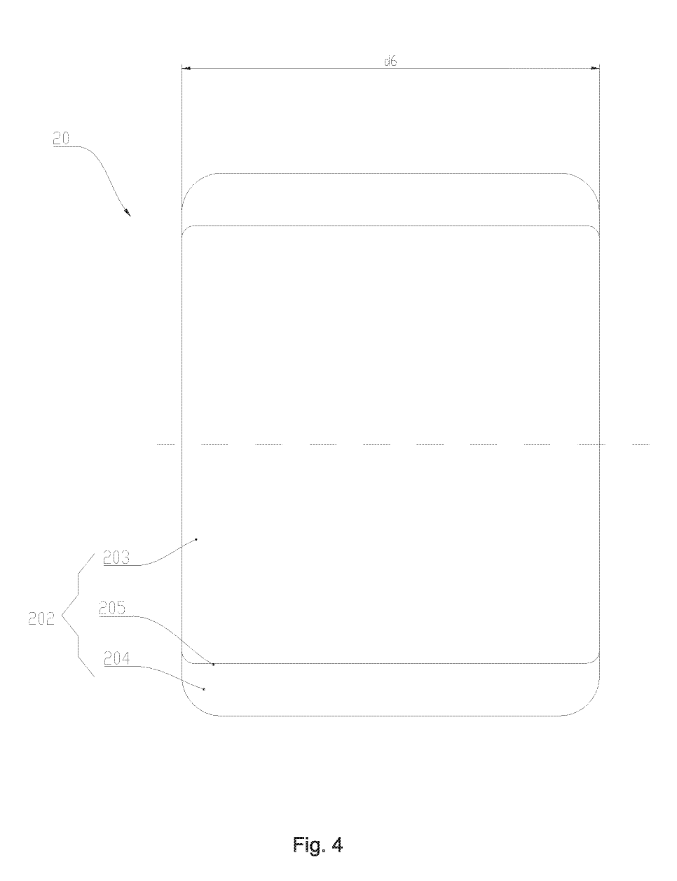

As shown in FIGS. 1 to 4, a motor structure for an electric wheelchair includes a housing 30, a front cover 10 fixed at a front of the housing 30, a rear cover 40 fixed at a back of the housing 30, a rotating shaft 501, a rotor 50 sleeved on the rotating shaft 501 and fixedly connected with the rotating shaft 501, a commutator 70 sleeved on the rotating shaft 501 and electrically connected to the rotor 50, and a brush power terminal 60 fixed to the front cover 10 and in contact with the commutator 70, and further includes a plurality of tile-shaped magnets 20 surrounding the rotor 50, a cross-section of each tile-shaped magnet 20 is a symmetric structure about an axis thereof, the tile-shaped magnet 20 includes an inner curved surface 201 and an outer curved surface 202, and a centre of a circle (O1) corresponding to the inner curved surface 201 and centres of circles (O1, O2, and O3) corresponding to the outer curved surface lie on a straight line and are distanced apart.

Because the centre of the circle (O1) corresponding to the inner curved surface 201 and the centres of the circles (O1, O2, and O3) corresponding to the outer curved surface 202 lie on a straight line and are distanced apart, therefore, magnetic waveforms generated by the tile-shaped magnets 20 are relatively smooth, electromagnetic interference is small, leading to relatively small current when starting the motor, the smaller the time constant, the smaller impact on the power source, the better control and safety as well as longer service life of the motor and electric wheelchair.

Specifically, as shown in FIGS. 1 to 4, the outer curved surface 202 includes a first arc portion 203, transition portions 205 extending from two ends of the first arc portion 203, and second arc portions 204 extending from the other end of the transition portion 205, the first arc portion 203 and the second arc portion 204 are evenly transitioned through the transition portions 205, a centre of a circle (O3) corresponding to the first arc portion 203 is located at an external side of the centre of the circle (O1) corresponding to the inner curved surface 201, the distance between the centre of the circle (O3) and the centre of the circle (O1) is d2, and d2 is 0.25˜0.26 mm. A centre of a circle (O1) corresponding to each transition portion 205 coincides with the centre of the circle (O1) corresponding to the inner curved surface 201, and a centre of a circle (O2) corresponding to each second arc portion 204 is located at an internal side of the centre of the circle (O1) corresponding to the inner curved surface 201, the distance between the centre of the circle (O2) and the centre of the circle (O1) is d5, and d3 is 0.35˜0.36 mm.

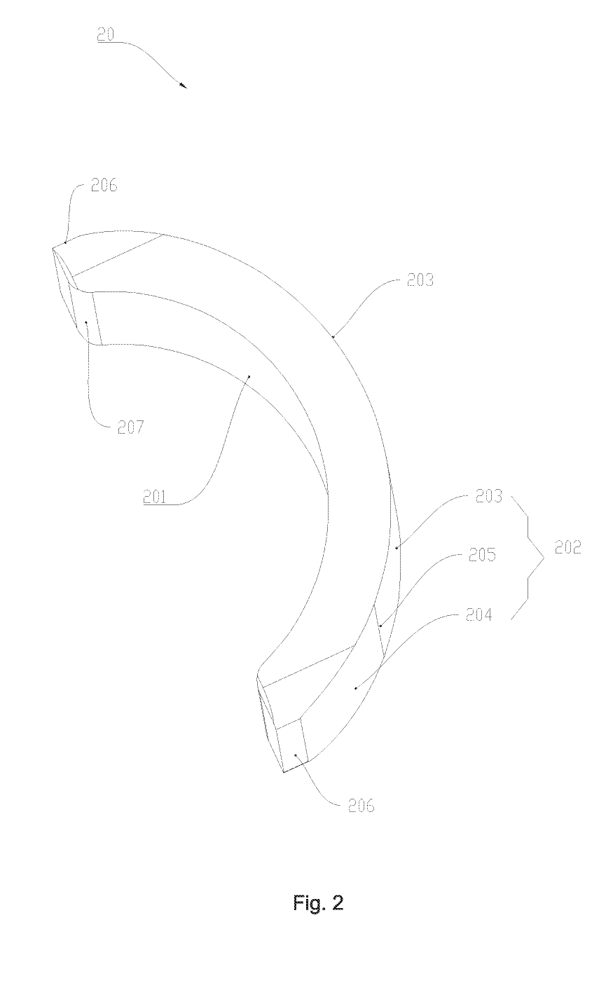

Furthermore, as shown in FIGS. 2 to 4, a corresponding radius R2 of the first arc portion 203 is 34.9 mm˜35.1 mm. A corresponding central angle of the first arc portion 203 is 90 degrees.

Furthermore, as shown in FIGS. 2 to 4, a corresponding radius R3 of each second arc portion 204 is 34.5 mm˜34.7 mm. An outer end of each second arc portion 204 is a horizontal plane 206 and the width d1 of the horizontal plane 206 is 3.1 mm˜3.3 mm, the horizontal distance between the outer edge of the horizontal plane 206 and the centre of circle (O1) of the inner curved surface 201 is d4. The vertex of the first arc portion 203 to the outer edge of the horizontal plane 206 is d3, and d3 is 27.05˜27.75 mm, wherein d3 plus d4 equals the radius R2.

Furthermore, as shown in FIGS. 2 to 4, a radius R1 of the inner curved surface 201 is 26.92 mm˜27.18 mm. Two ends of the inner curved surface 201 are provided with transition arcs 207, and radii of the transition arcs 207 are R4.

Furthermore, as shown in FIGS. 2 to 4, the width of the tile-shaped magnet 20 is d6, and d6 is 50.7 mm˜50.9 mm.

The remanent flux density Br of the tile-shaped magnet 20 is 3800 gauss˜4100 gauss, a high remanent flux density Br. Because of the same magnetic pole surface area and air gap, high Br can generate large output torque and large power. Motors can have a higher efficiency. Coercivity Hcb of the tile-shaped magnet 20 is 2800 oersted˜3400 oersted, because of high Hcb, it can be assured that the motor outputs the required electromotive force, so that the motor operating point is close to the maximum magnetic energy product and the ability of the magnet can be fully made use of. The intrinsic coercivity Hcj of the tile-shaped magnet 20 is 3300 oersted˜3700 oersted, high Hcj can ensure the motor to have higher overload demagnetization resistance as well as anti-aging and anti-hypothermia abilities. The maximum magnetic energy product (BH) max of the tile-shaped magnet 20 is 3.4 MGOe˜4.0 MGOe, the higher the (BH)max, the better the work factor of permanent magnet ferrite during the actual operation of the motor.

Specifically, as shown in FIG. 1, the commutator 70 includes a plurality of commutator segments 701, a surface roughness of each commutator segment 701 is 1.27 microns˜2.03 microns, a height difference between adjacent commutator segments 701 is less than or equal to 1.27 microns, a height difference between two sides of each commutator segment 701 is less than or equal to 1.27 microns, and a curvature of the commutator 70 composed of the plurality of commutator segments 701 is less than or equal to 2.54 microns. The number of commutator segments 701 is 16 pieces. 16 pieces of commutator segments 701 evenly surround the rotating shaft 501.

The above is a specific embodiment of the present invention, and it should be noted that those skilled in the art may make various improvements and modifications without departing from the principle of the present invention, and these improvements and modifications are also considered to be within the scope of the present invention.

What is claimed is:

1. A motor structure for an electric wheelchair, comprising a housing, a front cover fixed at a front of the housing, a rear cover fixed at a back of the housing, a rotating shaft, a rotor sleeved on the rotating shaft and fixedly connected with the rotating shaft, a commutator sleeved on the rotating shaft and electrically connected to the rotor, and a brush power terminal fixed to the front cover and in contact with the commutator, wherein the motor structure further comprises a plurality of tile-shaped magnets surrounding the rotor, a cross-section of each tile-shaped magnet is a symmetric structure about an axis thereof, each tile-shaped magnet comprises an inner curved surface and an outer curved surface, and a centre of a circle corresponding to the inner curved surface and centres of circles corresponding to the outer curved surface lie on a straight line and are distanced apart.

2. The motor structure for an electric wheelchair according to claim 1, wherein the outer curved surface comprises a first arc portion, transition portions extending from two ends of the first arc portion, and second arc portions extending from other ends of the transition portions, the first arc portion and the second arc portions are evenly transitioned through the transition portions, a centre of a circle corresponding to the first arc portion is located at an external side of the centre of the circle corresponding to the inner curved surface, a centre of a circle corresponding to each transition portion coincides with the centre of the circle corresponding to the inner curved surface, and a centre of a circle corresponding to each second arc portion is located at an internal side of the centre of the circle corresponding to the inner curved surface.

3. The motor structure for an electric wheelchair according to claim 2, wherein a corresponding radius of the first arc portion is 34.9 mm˜35.1 mm.

4. The motor structure for an electric wheelchair according to claim 2, wherein a corresponding central angle of the first arc portion is 90 degrees.

5. The motor structure for an electric wheelchair according to claim 2, wherein a corresponding radius of each second arc portion is 34.5 mm˜34.7 mm.

6. The motor structure for an electric wheelchair according to claim 5, wherein an outer end of each second arc portion is a horizontal plane and the width of the horizontal plane is 3.1 mm˜3.2 mm.

7. The motor structure for an electric wheelchair according to claim 1, wherein a corresponding radius of the inner curved surface is 26.92 mm˜27.18 mm.

8. The motor structure for an electric wheelchair according to claim 1, wherein two ends of the inner curved surface are provided with transition arcs.

9. The motor structure for an electric wheelchair according to claim 1, wherein the commutator comprises a plurality of commutator segments, a surface roughness of each commutator segment is 1.27 microns˜2.03 microns, a height difference between adjacent commutator segments is less than or equal to 1.27 microns, a height difference between two sides of each commutator segment is less than or equal to 1.27 microns, and a curvature of the commutator composed of the plurality of commutator segments is less than or equal to 2.54 microns.

10. The motor structure for an electric wheelchair according to claim 9, wherein the number of commutator segments is 16 pieces.
